(19) United States
(12) Patent Application Publication
(10) Pub. No.: US 2009/0175379 A1
(43) Pub. Date: Jul. 9, 2009

(54) Transmitter Identification For Wireless Signals Having A Digital Audio Broadcast Physical Layer

(75) Inventors: Dimitri Rubin, Cupertino, CA (US); David Burgess, Fairfield, CA (US); Guttorm Opshaug, Menlo Park, CA (US); Harvind Samra, Fairfield, CA (US)

Correspondence Address: LAW OFFICE OF RICHARD A. DUNNING, JR., 343 SOQUEL AVENUE, SUITE 311, SANTA CRUZ, CA, 95062, US

(73) Assignee: Rosum Corporation, Mountain View, CA (US)

(21) Appl. No.: 12/333,445

(22) Filed: Dec. 12, 2008

Related U.S. Application Data
(60) Provisional application No. 61/013,107, filed on Dec. 12, 2007.

(51) Int. Cl. H04L 27/00

(52) U.S. Cl. 375/295

(57) ABSTRACT

According to one embodiment, an apparatus having corresponding computer-readable media comprises: a transmitter marking module adapted to insert a pseudonoise sequence into a Null symbol of a digital audio broadcast (DAB) transmission frame; wherein the pseudonoise sequence represents an identity of a transmitter adapted to transmit a wireless signal representing the DAB transmission frame. According to another embodiment, an apparatus having corresponding computer-readable media comprises: a transmitter identification module adapted to identify a transmitter of a wireless signal representing a digital audio broadcast (DAB) transmission frame based on a pseudonoise sequence present in a Null symbol of the DAB transmission frame.

### CROSS-REFERENCE TO RELATED APPLICATIONS

This application claims benefit of U.S. Provisional Patent Application Ser. No. 61,013,107 filed Dec. 12, 2007, the disclosure thereof incorporated by reference herein in its entirety.

### FIELD

The present disclosure relates generally to position determination. More particularly, the present disclosure relates to transmitter identification for wireless signals having a digital audio broadcast (DAB) physical layer.

### BACKGROUND

Positioning receivers that are based on time-of-flight, such as GPS, rely on extremely precise measurements of signal arrival time from multiple transmitter sites. Each relative time-of-flight measurement, when combined with the propagation speed of the signal and precise knowledge of transmitter positions, represents a constraint on the possible receiver location. An estimate of position can be formed by combining several such constraints.

This approach to positioning has been considered unfeasible for broadcast transmissions that use SFN technology such as T-DMB, DMB, DVB, ISDB-T, DAB, MediaFLO and A-VSB networks. In an SFN network, geographically dispersed transmitters emit time-synchronized replica signals. Hence, the signals arriving from different towers are not identifiable.

One way to identify SFN transmitters is specified by ETSI EN 300 401 V1.4.1 2006-01: “Radio Broadcasting Systems; Digital Audio Broadcasting (DAB) to mobile, portable and fixed receivers” (also referred to herein as “the DAB specification”). For all transmission modes, the DAB specification defines the option to broadcast Transmitter Identification Information (TII) within null symbols of the DAB synchronization channel, as described in section 14.8 of the DAB specification, and to broadcast transmitter coordinates as part of the TII database message, as described in section 8.1.9 of the DAB specification. However, both of these facilities have shortcomings as described below.

The overall signal energy of the inserted TII signal is approximately 16 dB lower than the energy of the rest of the transmission frame, which limits the ability of a receiver to receive and uniquely process signals from transmitters located far from the receiver. In addition, the limited number of OFDM pilots used for the TII signal limits ranging accuracy in a rough multipath environment. Furthermore, while rules are provided to allocate unique discrete OFDM pilots to the transmitters, the solution still suffers from the near-far effect, thereby limiting the number of transmitters received and uniquely processed by a mobile receiver for positioning purposes.

The TII database message provides information regarding transmitter coordinates in two dimensions (that is, latitude and longitude) and timing information of the delays between transmitters in microseconds. However, this information is not sufficient to guarantee precise positioning because every microsecond of ambiguity results in a 300 m ranging uncertainty. In addition, no transmitter altitude information is provided, thereby degrading positioning performance in areas near the transmitter.

### SUMMARY

In general, in one aspect, an embodiment features an apparatus comprising: a transmitter marking module adapted to insert a pseudonoise sequence into a Null symbol of a digital audio broadcast (DAB) transmission frame; wherein the pseudonoise sequence represents an identity of a transmitter adapted to transmit a wireless signal representing the DAB transmission frame.

Embodiments of the apparatus can include one or more of the following features. In some embodiments, the pseudonoise sequence is selected from a group of mutually orthogonal pseudonoise sequences. In some embodiments, the transmitter marking module comprises: a pseudonoise sequence generator adapted to provide the pseudonoise sequence; and an insertion module adapted to insert the pseudonoise sequence into the Null symbol of the DAB transmission frame. In some embodiments, the transmitter marking module further comprises: a chip rotator adapted to rotate the pseudonoise sequence by a predetermined number of chips before the pseudonoise sequence is inserted into the Null symbol of the DAB transmission frame; wherein the pseudonoise sequence and the predetermined number of chips represent the identity of the transmitter. In some embodiments, the transmitter marking module further comprises: a transmitter identification information module to insert Transmitter Identification Information (TII) into the Null symbol of the DAB transmission frame. Some embodiments comprise a DAB module adapted to provide the DAB transmission frame. Some embodiments comprise the transmitter. In some embodiments, the wireless signal is a Terrestrial-Digital Multimedia Broadcasting (T-DMB) signal.

In general, in one aspect, an embodiment features a computer-readable media embodying instructions executable by a computer to perform a method comprising: inserting a pseudonoise sequence into a Null symbol of a digital audio broadcast (DAB) transmission frame; wherein the pseudonoise sequence represents an identity of a transmitter adapted to transmit a wireless signal representing the DAB transmission frame.

Embodiments of the computer-readable media can include one or more of the following features. In some embodiments, the pseudonoise sequence is selected from a group of mutually orthogonal pseudonoise sequences. In some embodiments, the method further comprises: rotating the pseudonoise sequence by a predetermined number of chips before the pseudonoise sequence is inserted into the Null symbol of the DAB transmission frame; wherein the pseudonoise sequence and the predetermined number of chips represent the identity of the transmitter. In some embodiments, the method further comprises: inserting Transmitter Identification Information (TII) into the Null symbol of the DAB transmission frame. In some embodiments, the wireless signal is a Terrestrial-Digital Multimedia Broadcasting (T-DMB) signal.

In general, in one aspect, an embodiment features an apparatus comprising: a transmitter identification module adapted to identify a transmitter of a wireless signal representing a digital audio broadcast (DAB) transmission frame based on a pseudonoise sequence present in a Null symbol of the DAB transmission frame.

Embodiments of the apparatus can include one or more of the following features. In some embodiments, the transmitter identification module comprises: a correlator adapted to identify the transmitter based on the pseudonoise sequence and a chip rotation of the pseudonoise sequence. In some embodiments, the pseudonoise sequence is selected from a group of mutually orthogonal pseudonoise sequences. In some embodiments, the transmitter identification module comprises: a transmitter identification information module to obtain Transmitter Identification Information (TII) from the Null symbol of the DAB transmission frame; wherein the transmitter identification module is further adapted to identify the transmitter of the wireless signal representing the DAB transmission frame based on the Transmitter Identification Information. Some embodiments comprise a receiver adapted to receive the wireless signal representing the DAB transmission frame. Some embodiments comprise a pseudorange module adapted to obtain a pseudorange based on the pseudonoise sequence. Some embodiments comprise a position module adapted to determine a position of the apparatus based on the pseudorange. In some embodiments, the wireless signal is a Terrestrial-Digital Multimedia Broadcasting (T-DMB) signal.

In general, in one aspect, an embodiment features computer-readable media embodying instructions executable by a computer to perform a method comprising: identifying a transmitter of a wireless signal representing a digital audio broadcast (DAB) transmission frame based on a pseudonoise sequence present in a Null symbol of the DAB transmission frame.

Embodiments of the computer-readable media can include one or more of the following features. In some embodiments, the method further comprises: identifying the transmitter based on the pseudonoise sequence and a chip rotation of the pseudonoise sequence. In some embodiments, the pseudonoise sequence is selected from a group of mutually orthogonal pseudonoise sequences. In some embodiments, the method further comprises: obtaining Transmitter Identification Information (TII) from the Null symbol of the DAB transmission frame; and identifying the transmitter of the wireless signal representing the DAB transmission frame based on the Transmitter Identification Information. In some embodiments, the method further comprises: obtaining a pseudorange based on the pseudonoise sequence. In some embodiments, the method further comprises: determining a position of a receiver of the wireless signal based on the pseudorange. In some embodiments, the wireless signal is a Terrestrial-Digital Multimedia Broadcasting (T-DMB) signal.

In general, in one aspect, an embodiment features an apparatus comprising: transmitter marking means for inserting a pseudonoise sequence into a Null symbol of a digital audio broadcast (DAB) transmission frame; wherein the pseudonoise sequence represents an identity of a transmitter adapted to transmit a wireless signal representing the DAB transmission frame.

Embodiments of the apparatus can include one or more of the following features. In some embodiments, the pseudonoise sequence is selected from a group of mutually orthogonal pseudonoise sequences. In some embodiments, the transmitter marking means comprises: pseudonoise sequence generator means for providing the pseudonoise sequence; and insertion means for inserting the pseudonoise sequence into the Null symbol of the DAB transmission frame. In some embodiments, the transmitter marking means further comprises: chip rotator means for rotating the pseudonoise sequence by a predetermined number of chips before the pseudonoise sequence is inserted into the Null symbol of the DAB transmission frame; wherein the pseudonoise sequence and the predetermined number of chips represent the identity of the transmitter. In some embodiments, the transmitter marking means further comprises: transmitter identification information means for inserting Transmitter Identification Information (TII) into the Null symbol of the DAB transmission frame. Some embodiments comprise means for providing the DAB transmission frame. Some embodiments comprise means for transmitting the wireless signal. In some embodiments, the wireless signal is a Terrestrial-Digital Multimedia Broadcasting (T-DMB) signal.

In general, in one aspect, an embodiment features a method comprising: inserting a pseudonoise sequence into a Null symbol of a digital audio broadcast (DAB) transmission frame; wherein the pseudonoise sequence represents an identity of a transmitter adapted to transmit a wireless signal representing the DAB transmission frame.

Embodiments of the method can include one or more of the following features. In some embodiments, the pseudonoise sequence is selected from a group of mutually orthogonal pseudonoise sequences. Some embodiments comprise providing the pseudonoise sequence; and inserting the pseudonoise sequence into the Null symbol of the DAB transmission frame. Some embodiments comprise rotating the pseudonoise sequence by a predetermined number of chips before the pseudonoise sequence is inserted into the Null symbol of the DAB transmission frame; wherein the pseudonoise sequence and the predetermined number of chips represent the identity of the transmitter. Some embodiments comprise inserting Transmitter Identification Information (TII) into the Null symbol of the DAB transmission frame. Some embodiments comprise providing the DAB transmission frame. Some embodiments comprise transmitting the wireless signal. In some embodiments, the wireless signal is a Terrestrial-Digital Multimedia Broadcasting (T-DMB) signal.

In general, in one aspect, an embodiment features an apparatus comprising: transmitter identification means for identifying a transmitter of a wireless signal representing a digital audio broadcast (DAB) transmission frame based on a pseudonoise sequence present in a Null symbol of the DAB transmission frame.

Embodiments of the apparatus can include one or more of the following features. In some embodiments, the transmitter identification means comprises: correlator means for identifying the transmitter based on the pseudonoise sequence and a chip rotation of the pseudonoise sequence. In some embodiments, the pseudonoise sequence is selected from a group of mutually orthogonal pseudonoise sequences. In some embodiments, the transmitter identification means comprises: transmitter identification information means for obtaining Transmitter Identification Information (TII) from the Null symbol of the DAB transmission frame; wherein the transmitter identification means is further adapted to identify the transmitter of the wireless signal representing the DAB transmission frame based on the Transmitter Identification Information. Some embodiments comprise receiver means for receiving the wireless signal representing the DAB transmission frame. Some embodiments comprise pseudorange means for obtaining a pseudorange based on the pseudonoise sequence. Some embodiments comprise position means for determining a position of the apparatus based on the pseudorange. In some embodiments, the wireless signal is a Terrestrial-Digital Multimedia Broadcasting (T-DMB) signal.

In general, in one aspect, an embodiment features a method comprising: identifying a transmitter of a wireless signal representing a digital audio broadcast (DAB) transmission frame based on a pseudonoise sequence present in a Null symbol of the DAB transmission frame.

Embodiments of the method can include one or more of the following features. Some embodiments comprise identifying the transmitter based on the pseudonoise sequence and a chip rotation of the pseudonoise sequence. In some embodiments, the pseudonoise sequence is selected from a group of mutually orthogonal pseudonoise sequences. Some embodiments comprise obtaining Transmitter Identification Information (TII) from the Null symbol of the DAB transmission frame; and identifying the transmitter of the wireless signal representing the DAB transmission frame based on the Transmitter Identification Information. Some embodiments comprise receiving the wireless signal representing the DAB transmission frame. Some embodiments comprise obtaining a pseudorange based on the pseudonoise sequence. Some embodiments comprise determining a position of the method based on the pseudorange. In some embodiments, the wireless signal is a Terrestrial-Digital Multimedia Broadcasting (T-DMB) signal.

The details of one or more implementations are set forth in the accompanying drawings and the description below. Other features will be apparent from the description and drawings, and from the claims.

### DESCRIPTION OF DRAWINGS

FIG. 1 shows a communication system comprising a user terminal receiving wireless signals, each having a DAB physical layer, from a plurality of respective transmitting stations according to an embodiment of the present invention.

FIG. 2 shows detail of a transmitting station of FIG. 1 according to an embodiment of the present invention.

FIG. 3 shows a process for the transmitting station of FIG. 2 according to some embodiments of the present invention.

FIG. 4 shows a typical DAB transmission frame.

FIG. 5 shows the transmitted DAB signal S(t) as a sequence of DAB transmission frames.

FIG. 6 shows a schedule for six transmitting stations according to one embodiment.

FIG. 7 illustrates insertion of a 1023-chip PN sequence into a DAB transmission frame in DAB transmission mode I.

FIG. 8 shows detail of the user terminal of FIG. 1 according to an embodiment of the present invention.

FIG. 9 shows a process for the user terminal of FIG. 8 according to some embodiments of the present invention.

The leading digit(s) of each reference numeral used in this specification indicates the number of the drawing in which the reference numeral first appears.

### DETAILED DESCRIPTION

Embodiments of the present invention provide transmitter identification for wireless signals having a digital audio broadcast (DAB) physical layer. Wireless signals having a DAB physical layer include Digital Multimedia Broadcasting (DMB) signals, Terrestrial-Digital Multimedia Broadcasting (T-DMB) signals, other single-frequency network (SFN) signals, and the like. Transmitter identification allows these signals to be used for position determination of mobile devices, also referred to generally herein as “user terminals.”

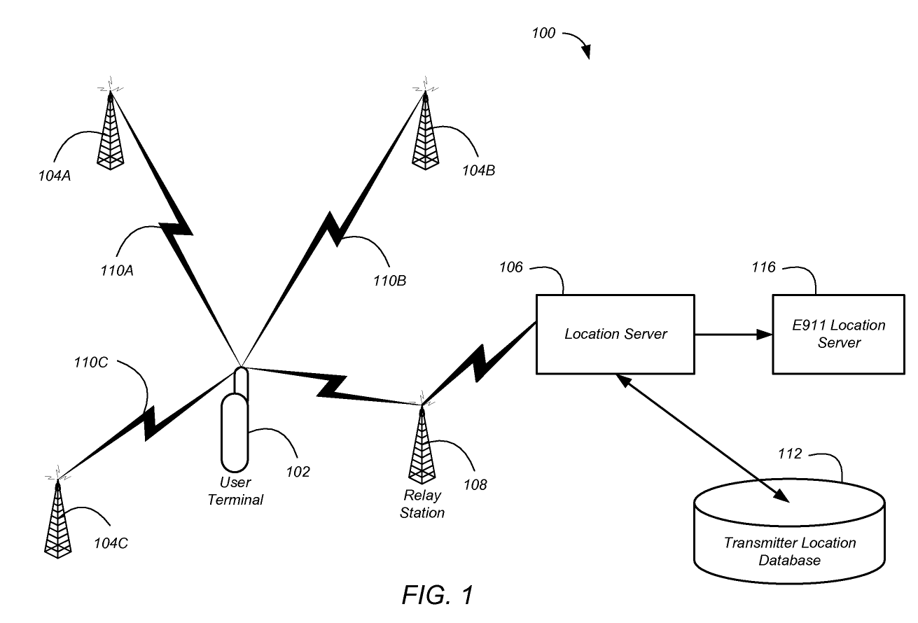

FIG. 1 shows a communication system 100 comprising a user terminal 102 receiving wireless signals 110A-C, each having a DAB physical layer, from a plurality of respective transmitting stations 104A-C according to an embodiment of the present invention. Although in the described embodiments, the elements of communication system 100 are presented in one arrangement, other embodiments may feature other arrangements, as will be apparent to one skilled in the relevant arts based on the disclosure and teachings provided herein. For example, the elements of communication system 100 can be implemented in hardware, software, or combinations thereof.

The phrase “user terminal” is meant to refer to any object capable of implementing the techniques described herein. Examples of user terminals include PDAs, mobile phones, cars and other vehicles, and any object which could include a chip or software implementing the techniques described herein. Further, the term “user terminal” is not intended to be limited to objects which are “terminals” or which are operated by “users.”

In some embodiments, user terminal 102 performs the techniques described herein. In other embodiments, some of the techniques are performed by a location server 106 based on data collected by user terminal 102 and relayed by a relay station 108 such as a cellular base station and the like. The locations of transmitting stations 104 can be stored in a transmitter location database 112. The location of user terminal 102 can be transmitted to an E911 location server 116 for emergencies.

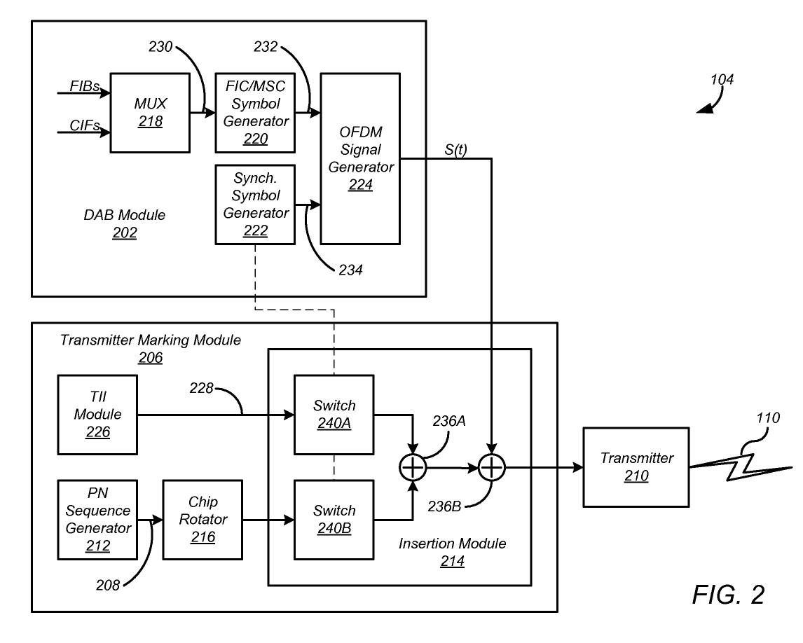

FIG. 2 shows detail of a transmitting station 104 of FIG. 1 according to an embodiment of the present invention. Although in the described embodiments, the elements of transmitting station 104 are presented in one arrangement, other embodiments may feature other arrangements, as will be apparent to one skilled in the relevant arts based on the disclosure and teachings provided herein. For example, the elements of transmitting station 104 can be implemented in hardware, software, or combinations thereof.

Referring to FIG. 2, transmitting station 104 includes a DAB module 202 adapted to provide a signal S(t) including DAB transmission frames, a transmitter marking module 206 adapted to insert a pseudonoise sequence 208 into a Null symbol of one or more of the DAB transmission frames, and a transmitter 210 adapted to transmit a wireless signal 110 (FIG. 1) representing the DAB transmission frames. Wireless signal 110 can be a Terrestrial-Digital Multimedia Broadcasting (T-DMB) signal or the like.

Transmitter marking module 206 includes a pseudonoise (PN) sequence generator 212 adapted to provide pseudonoise sequence 208, and an insertion module 214 adapted to insert pseudonoise sequence 208 into Null symbols of DAB transmission frames. In some embodiments, transmitter marking module 206 includes a chip rotator 216 adapted to rotate pseudonoise sequence 208 by a predetermined number of chips before pseudonoise sequence 208 is inserted into Null symbols of DAB transmission frames. In some embodiments, transmitter marking module 206 also includes a transmitter identification information (TII) module 226 adapted to insert Transmitter Identification Information (TII) into Null symbols of DAB transmission frames. Insertion module 214 includes switches 240A, B and combiners 236A, B.

DAB module 202 includes a transmission frame multiplexer (MUX) 218, a FIC/MSC symbol generator 220, a synchronization channel (Synch.) symbol generator 222, and an OFDM signal generator 224.

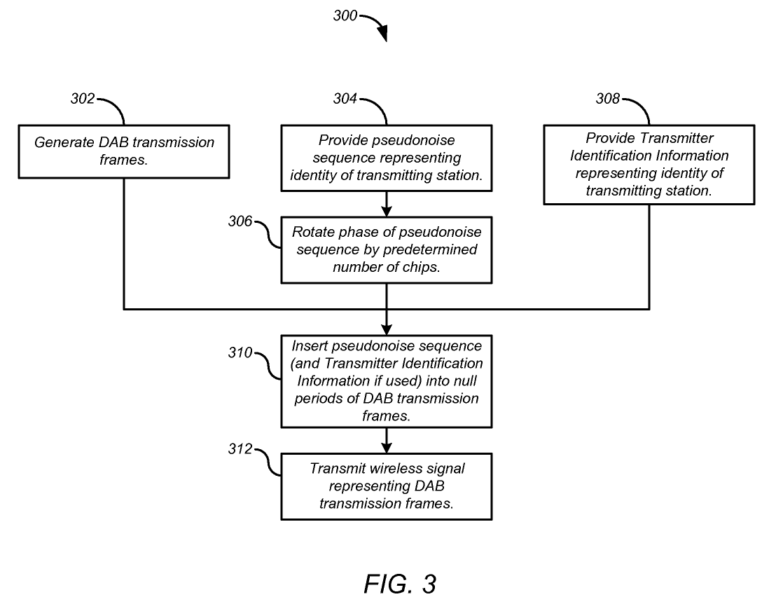

FIG. 3 shows a process 300 for transmitting station 104 of FIG. 2 according to some embodiments of the present invention. Although in the described embodiments, the elements of process 300 are presented in one arrangement, other embodiments may feature other arrangements, as will be apparent to one skilled in the relevant arts based on the disclosure and teachings provided herein. For example, in various embodiments, some or all of the steps of process 300 can be executed in a different order, concurrently, and the like.

Referring to FIG. 3, DAB module 202 generates DAB transmission frames (step 302). In particular, transmission frame multiplexer 218 multiplexes fast information blocks (FIB) and common interleaved frames (CIF). Symbol generator 220 generates OFDM symbols 232 representing the result 230. Symbol generator 222 generates synchronization channel symbols 234 including phase reference symbols (PRS). OFDM signal generator 224 generates an OFDM signal S(t) representing symbols 232 and 234.

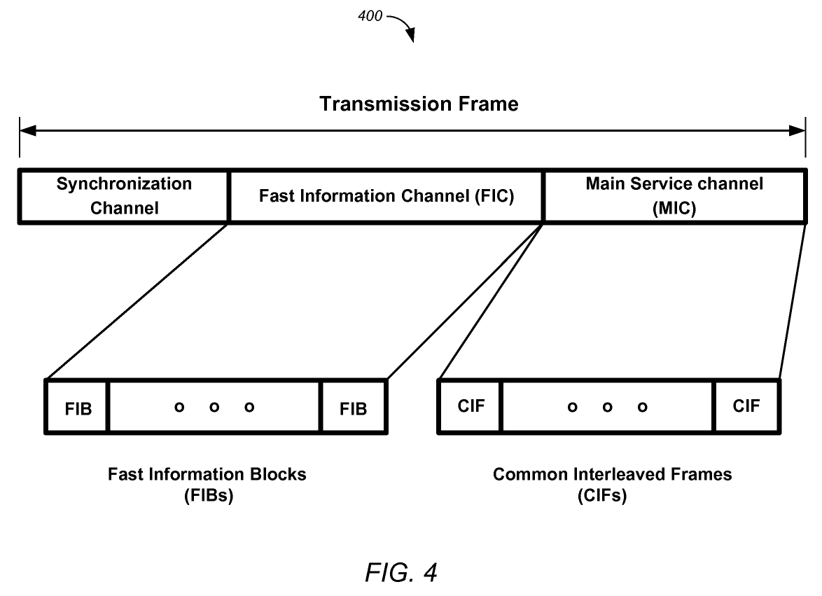

FIG. 4 shows a typical DAB transmission frame 400. Digital Audio Broadcasting (DAB) is a standard, established in 1995 by the European Telecommunications Standards Institute (ETSI), to be the digital successor to current analog audio broadcasting based on AM and FM. DAB was the first standard to use OFDM. One important reason to use OFDM for DAB is the possibility to use a single frequency network, which greatly enhances spectrum efficiency. In such a single frequency network two or more transmitters may be sending the same signal, with different delays, to a receiver. With OFDM, receivers can more easily handle this “apparent multipath” created by these transmitters.

In order to allow the DAB system to be used in different transmission network configurations and over a wide range of operating frequencies, four transmission modes are defined as shown in Table 1.

TABLE 1

| | Duration of | Number of FIBs | Number of CIFs |
|---|---|---|---|
| Transmission | Transmission | per Transmission | per Transmission |
| Modes | Frame | Frame | Frame |
| I | 96 ms | 12 | 4 |
| II | 24 ms | 3 | 1 |
| III | 24 ms | 4 | 1 |
| IV | 48 ms | 6 | 4 |

In each of these four transmission modes there is a DAB transmission frame 400 consisting of three types of channels. Referring to FIG. 4, the Main Service Channel (MSC) is used to carry audio and data service components consisting of Common Interleaved Frames (CIFs). The Fast Information Channel (FIC) is a non-time-interleaved used for rapid access of information by a receiver. This FIC channel consists of Fast Information Blocks (FIBs). The Synchronization Channel is used for aiding the receivers' basic demodulator functions, such as transmission frame synchronization, automatic frequency control, channel state estimation, and transmitter identification.

Each DAB transmission frame 400 consists of consecutive OFDM symbols. The number of OFDM symbols in a DAB transmission frame 400 is dependent on the transmission mode. The synchronization channel in any transmission mode occupies the first two OFDM symbol in each DAB transmission frame 400.

The first OFDM symbol of DAB transmission frame 400 is the Null symbol of duration T_{NULL}. The remaining part of DAB transmission frame 400 are OFDM symbols of duration T_{S}. These OFDM symbols are modulated carriers with spacing equal to 1/T_{U}. Here T_{S}=T_{U}+Δ where Δ is a guard interval.

The four transmission modes have the parameter values shown in Table 2.

TABLE 2

| Parameter | Mode I | | Mode II | | Mode III | | Mode IV | |
|---|---|---|---|---|---|---|---|---|
| L | 76 | | 76 | | 153 | | 76 | |
| K | 1536 | | 384 | | 192 | | 768 | |
| T_{F} | 196608 | T | 49152 | T | 49152 | T | 98304 | T |
| | (96 | ms) | (24 | ms) | (24 | ms) | (48 | ms) |
| T_{NULL} | 2656 | T | 664 | T | 345 | T | 1328 | T |
| | (1.297 | ms) | (0.324 | ms) | (0.168 | ms) | (0.648 | ms) |
| T_{S} | 2552 | T | 638 | T | 319 | T | 1276 | T |
| | (1.246 | ms) | (0.312 | ms) | (0.156 | ms) | (0.623 | ms) |
| T_{U} | 2048 | T | 512 | T | 256 | T | 1024 | T |
| | (1.0 | ms) | (0.250 | ms) | (0.125 | ms) | (0.500 | ms) |
| Δ | 504 | T | 126 | T | 63 | T | 252 | T |
| | (0.246 | ms) | (0.062 | ms) | (0.031 | ms) | (0.123 | ms) |

Here T=1/2048000 seconds=0.4883 microseconds. L is the number of OFDM symbols per transmission frame. K is the number of transmission carriers. T_{F} is the transmission frame duration. T_{NULL} is the Null symbol duration (Null symbol not included in L). T_{S} is the duration of OFDM symbols (Null symbol is different). T_{U} is the inverse carrier spacing. A is the duration of the time interval called guard interval.

The synchronization channel in any transmission mode occupies the first two OFDM symbols of each DAB transmission frame, and consists of the Null symbol and the phase reference symbol (PRS). The Null symbol at the beginning of each DAB transmission frame 400 has the main signal equal to 0. Thus at the beginning of each DAB transmission frame 400 there is no signal during T_{NULL} seconds.

The second OFDM symbol of DAB transmission frame 400 is the phase reference symbol (PRS), which sets the phase reference at the receivers for the following symbols. This phase reference symbol has duration of T_{S} seconds. Here all the K carriers are modulated using differentially encoded Quadrature Phase Shift Keying (D-QPSK) modulation. The demodulator for this modulation uses the previous symbol as a reference for demodulation of the current symbol. Here the known phases used to modulate each of the K D-QPSK modulated carriers are fixed for each of the four transmission modes. The phase reference symbol consisting of K D-QPSK modulated carriers is a known signal component that is used by embodiments of the present invention to compute a pseudorange to the tower transmitting the DAB signal.

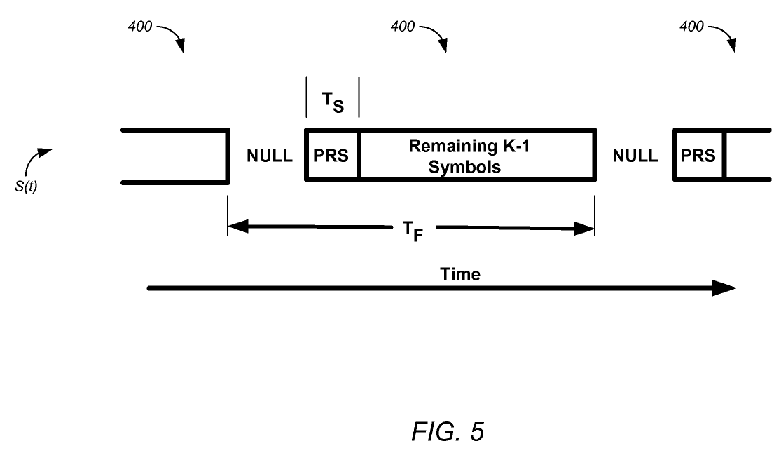

FIG. 5 shows the transmitted DAB signal S(t) as a sequence of DAB transmission frames 400. Each DAB transmission frame 400 includes a Null symbol (no signal) followed by the known Phase Reference Symbol (PRS), which is then followed by the remaining K-1 symbols of the DAB transmission frame 400.

Except for the Null symbol, the normal symbols consist of K carriers modulated by D-QPSK. Embodiments of the present invention can use as the reference waveform the Phase Reference Symbol (PRS) of duration T_{S} seconds located right after the first Null symbol in each DAB transmission frame 400. These frames 400 occur every T_{F} seconds. The signal parameters are summarized in Table 3.

TABLE 3

| Parameter | Mode I | Mode II | Mode III | Mode IV |
|---|---|---|---|---|
| T_{F} | 96 ms | 24 ms | 24 ms | 48 ms |
| T_{S} | 1.246 ms | 0.312 ms | 0.156 ms | 0.623 ms |

Thus, for example, in Mode II every 24 ms a new frame occurs with the known PRS of duration 312 microseconds at the beginning of each frame after the null symbol. Embodiments of the present invention can correlate the known PRS waveform in a frame to obtain a pseudorange from user terminal 102 to the transmitting station 104 transmitting the DAB signal 110. Embodiments of the present invention can also correlate with several PRS waveforms of multiple DAB transmission frames 400.

Referring again to FIGS. 2 and 3, pseudonoise sequence generator 212 provides a pseudonoise sequence 208 that represents the identity of transmitting station 104 (step 304). In some embodiments, pseudonoise sequence 208 is selected from a group of mutually orthogonal pseudonoise sequences. This selection aids accurate identification of the PN sequences on reception.

In some embodiments, chip rotator 216 rotates pseudonoise sequence 208 by a predetermined number of ships before pseudonoise sequence 208 is inserted into the Null symbol of a DAB transmission frame 400 (step 306). In these embodiments, the pseudonoise sequence 208 and the predetermined chip rotation together represent the identity of transmitting station 104. This rotation can increase the number of different transmitters that can be identified by a set of orthogonal PN sequences, as described in detail below.

In some embodiments, transmitter marking module 206 also inserts Transmitter Identification Information (TII) into Null symbols of DAB transmission frames 400. According to these embodiments, TII module 226 provides Transmitter Identification Information 228 that represents the identity of transmitting station 104 (step 308).

Insertion module 214 inserts pseudonoise sequence 208, and Transmitter Identification Information 228 if used, into Null symbols of DAB transmission frames 400 (step 310). Insertion module 214 can be implemented at baseband, IF, or RF. Switches 240A, B operate according to synchronization channel symbol generator 222 of DAB module 202 to accurately insert pseudonoise sequence 208, and Transmitter Identification Information 228 if used. Combiner 236A combines pseudonoise sequence 208 and Transmitter Identification Information 228. Combiner 236B combines the resulting signal with signal S(t) provided by DAB module 202. Transmitter 210 transmits wireless signal 110 representing signal S(t) (step 312).

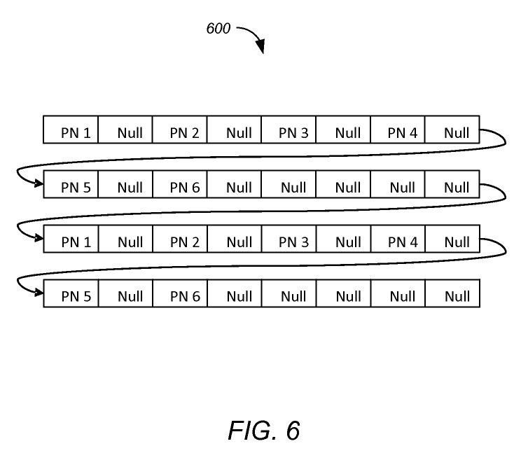

In some embodiments, transmitting stations 104 insert pseudonoise sequences 208 according to a TDMA schedule so that no two transmitting stations 104 share the same Null symbol in the same geographic area. FIG. 6 shows a schedule 600 for six transmitting stations 104 according to one embodiment. The 32 blocks in FIG. 6 represents the Null symbols of 32 consecutive DAB transmission frames 400.

Preferably some of the Null symbols in the schedule are left unused (no signal). In the example schedule 600 of FIG. 6, at least every other Null symbol is left unused. Retaining at least some unused Null symbols allows receivers to perform Signal-to-Noise Ratio (SNR) calculations and the like for wireless signal 110. In FIG. 6, each of the six transmitting stations 104 in schedule 600 is represented by a respective pseudonoise sequence PN1-PN6. The six sequences occur, in order, every other DAB transmission frame 400, and are repeated after several DAB transmission frames 400 having no data during the Null symbol.

Schedule 600 can be broadcast to transmitting stations 104, for example using the DAB data channel, a separate communications channel, or the like. To ensure coordination of transmitting stations 104 in observing schedule 600, each transmitting station 104 can set the time offset of its first emitted Null symbol relative to GPS time (modulo GPS week).

Different PN sequence lengths can be selected for insertion in the Null symbols, and can be selected according to DAB transmission mode. For example, for DAB transmission mode I, a 1023-chip PN sequence can be used, which allows for 60 unique PN codes, allowing unique identification of 60 transmitting stations 104. For other DAB transmission modes, other lengths can be used. For example, for DAB transmission mode II, a 511-chip PN sequence can be used.

For a T-DMB signal, the 1023-chip PN sequence can be added at a signal level below that of the nominal T-DMB signal level. This “bury” ratio guarantees that current T-DMB receivers are not impacted by the addition of the 1023-chip PN sequence. This implementation improves the reception range of the receiver because the main autocorrelation peak of the 1023-chip PN sequence provides approximately 60 dB gain relative to the next strongest “sidelobe,” and provides approximately 32 dB processing gain in DAB transmission mode I with a chipping rate of 1.5 MHz. The overall link budget would be decreased dB for dB by a “bury” ratio.

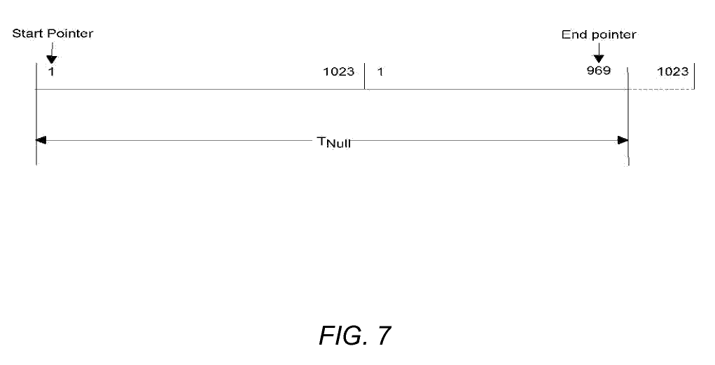

The selected PN sequence should be short enough so that an entire PN sequence can be inserted into a single Null symbol. Any remainder of the Null symbol can be filled by restarting the PN sequence, for example as shown in FIG. 7 for a 1023-chip PN sequence in DAB transmission mode I. The PN sequence, and its truncated repetition, will produce two correlation peaks, with the second peak delayed by an interval corresponding to approximately 200 km. Therefore in such embodiments any chip rotation should correspond to less than 100 km to avoid ambiguity.

As mentioned above, multiple transmitting stations 104 can share a single Null symbol by using different chip rotations. For example, in DAB transmission mode I, three transmitting stations 104 can share a single Null symbol using chip rotations that differ by shifts corresponding to 60 km. The timing of the phase reference symbol following a Null symbol can be used to accurately determine the chip rotations of the pseudonoise sequences present in that Null symbol.

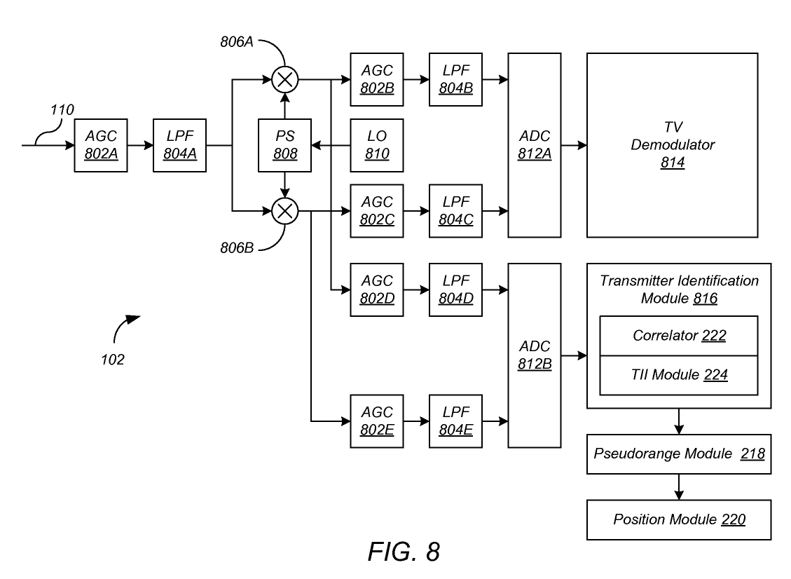

Referring again to FIG. 1, devices such as user terminal 102 that receive wireless signal 110 can identify the transmitting station 104 of signal 110 based on the pseuodonoise sequence present during Null symbols of the DAB transmission frames 400 represented by signal 110. FIG. 8 shows detail of user terminal 102 of FIG. 1 according to an embodiment of the present invention. Although in the described embodiments, the elements of user terminal 102 are presented in one arrangement, other embodiments may feature other arrangements, as will be apparent to one skilled in the relevant arts based on the disclosure and teachings provided herein. For example, the elements of user terminal 102 can be implemented in hardware, software, or combinations thereof.

Referring to FIG. 8, user terminal 102 includes automatic gain controllers (AGC) 802A-E, low-pass filters (LPF) 804A-E, mixers 806A, B, 90-degree phase splitter (PS) 808, local oscillator (LO) 810, analog-to-digital converters (ADC) 812A, B, TV demodulator 814, transmitter identification module 816, pseudorange module 818 and position module 820. Transmitter identification module 816 includes a correlator 822 and a transmitter identification information (TII) module 824.

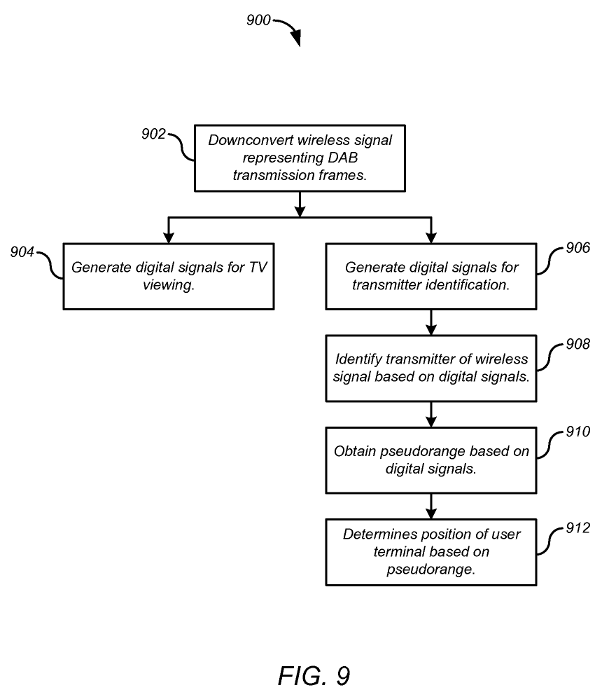

FIG. 9 shows a process 900 for user terminal 102 of FIG. 8 according to some embodiments of the present invention. Although in the described embodiments, the elements of process 900 are presented in one arrangement, other embodiments may feature other arrangements, as will be apparent to one skilled in the relevant arts based on the disclosure and teachings provided herein. For example, in various embodiments, some or all of the steps of process 900 can be executed in a different order, concurrently, and the like.

Referring to FIGS. 8 and 9, wireless signal 110 (FIG. 1) is demodulated (step 902). In particular, wireless signal 110 is amplified by AGC 802A, filtered by LPF 804A, and down converted by mixers 806, which are fed by 90-degree phase splitter 808 in accordance with local oscillator 810. The resulting I and Q signals are then processed by separate processing chains for television viewing and transmitter identification.

For television viewing, the I and Q signals are amplified by AGCs 802B, C, and filtered by LPFs 804B, C, respectively, before being digitized by ADC 812A. The resulting digital signals are passed to TV demodulator 814 (step 904).

For transmitter identification, the I and Q signals are amplified by AGCs 802D, E, and filtered by LPFs 804D, E, respectively, before being digitized by ADC 812B. The resulting digital signals are passed to transmitter identification module 816 (step 906). Transmitter identification module 816 identifies the transmitter of wireless signal 110 based on the digital signals (step 908).

In particular, correlator 822 correlates the Null symbols of the digital signals with reference signals to identify any PN sequence present during the Null symbols. The PN sequences are compared to a table that associates the PN sequences with transmitter identifiers. In embodiments employing chip rotations, the table includes the chip rotations as well. This table can be provisioned with user terminal 102, uploaded to user terminal 102 over the DAB data channel or a separate communications channel, and the like.

In embodiments employing Transmitter Identification Information (TII), transmitter identification information module 824 obtains Transmitter Identification Information (TII) from the Null symbol of the DAB transmission frame, and identifies the transmitter of the wireless signal 110 based on the Transmitter Identification Information.

In some embodiments, user terminal 102 obtains a pseudorange based on wireless signal 110 (step 910). In these embodiments, pseudorange module 818 can obtain a pseudorange based on pseudonoise sequences present in the Null symbols of DAB transmission frames 400, phase reference symbols present in the DAB transmission frames 400, or both.

In some embodiments, user terminal 102 determines its position based on the pseudorange (step 912). In these embodiments, position module 820 determines the position of user terminal 102 based on one or more of the pseudoranges generated by pseudorange module 818 and the locations of the transmitting stations 104 associated with the pseudoranges. Because the transmitting stations 104 associated with these pseudoranges have been identified, the locations of the corresponding transmitting stations 104 can be determined. These locations can be uploaded to user terminal 102 over the DAB data channel, using a separate communications channel, or the like, and can be stored in the table of pseudonoise sequences in user terminal 102. Position module 820 determines the position of user terminal 102 based on the pseudoranges and the locations of the associated transmitting stations 104. The position determination can include other ranges and pseudoranges as well. For example, GPS signals can be used.

In some embodiments, the position of user terminal 102 is determined by location server 106 (FIG. 1). According to these embodiments, the pseudoranges obtained by pseudorange module 818, and the identities of the associated transmitting stations 104, are transmitted to location server 106, for example by relay station 108 (FIG. 1). Location server 106 determines the locations of the transmitting stations 104 associated with the pseudoranges, and determines the position of user terminal 102 based on the pseudoranges and the locations of the transmitting stations 104.

As described above, user terminal 102 of FIG. 8 includes separate processing chains for television viewing and transmitter identification. This arrangement allows different gains to be applied for television viewing and transmitter identification. In particular, more gain is generally used for transmitter identification. However, user terminal 102 can be simplified by providing only a single processing chain that is used for both television viewing and transmitter identification. In such embodiments, the gain can be increased during transmitter identification operations if necessary.

Embodiments of the invention can be implemented in digital electronic circuitry, or in computer hardware, firmware, software, or in combinations of them. Embodiments of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
a transmitter marking module adapted to insert a pseudonoise sequence into a Null symbol of a digital audio broadcast (DAB) transmission frame;
wherein the pseudonoise sequence represents an identity of a transmitter adapted to transmit a wireless signal representing the DAB transmission frame.

2. The apparatus of claim 1:
wherein the pseudonoise sequence is selected from a group of mutually orthogonal pseudonoise sequences.

3. The apparatus of claim 1, wherein the transmitter marking module comprises:
a pseudonoise sequence generator adapted to provide the pseudonoise sequence; and
an insertion module adapted to insert the pseudonoise sequence into the Null symbol of the DAB transmission frame.

4. The apparatus of claim 3, wherein the transmitter marking module further comprises:
a chip rotator adapted to rotate the pseudonoise sequence by a predetermined number of chips before the pseudonoise sequence is inserted into the Null symbol of the DAB transmission frame;
wherein the pseudonoise sequence and the predetermined number of chips represent the identity of the transmitter.

5. The apparatus of claim 3, wherein the transmitter marking module further comprises:
a transmitter identification information module to insert Transmitter Identification Information (TII) into the Null symbol of the DAB transmission frame.

6. The apparatus of claim 3, further comprising:
a DAB module adapted to provide the DAB transmission frame.

7. The apparatus of claim 6, further comprising:
the transmitter.

8. The apparatus of claim 1:
wherein the wireless signal is a Terrestrial-Digital Multimedia Broadcasting (T-DMB) signal.

9. Computer-readable media embodying instructions executable by a computer to perform a method comprising:
inserting a pseudonoise sequence into a Null symbol of a digital audio broadcast (DAB) transmission frame;
wherein the pseudonoise sequence represents an identity of a transmitter adapted to transmit a wireless signal representing the DAB transmission frame.

10. The computer-readable media of claim 9:
wherein the pseudonoise sequence is selected from a group of mutually orthogonal pseudonoise sequences.

11. The computer-readable media of claim 9, wherein the method further comprises:
rotating the pseudonoise sequence by a predetermined number of chips before the pseudonoise sequence is inserted into the Null symbol of the DAB transmission frame;
wherein the pseudonoise sequence and the predetermined number of chips represent the identity of the transmitter.

12. The computer-readable media of claim 9, wherein the method further comprises:
inserting Transmitter Identification Information (TII) into the Null symbol of the DAB transmission frame.

13. The computer-readable media of claim 9:
wherein the wireless signal is a Terrestrial-Digital Multimedia Broadcasting (T-DMB) signal.

14. An apparatus comprising:
a transmitter identification module adapted to identify a transmitter of a wireless signal representing a digital audio broadcast (DAB) transmission frame based on a pseudonoise sequence present in a Null symbol of the DAB transmission frame.

15. The apparatus of claim 14, wherein the transmitter identification module comprises:
a correlator adapted to identify the transmitter based on the pseudonoise sequence and a chip rotation of the pseudonoise sequence.

16. The apparatus of claim 14:
wherein the pseudonoise sequence is selected from a group of mutually orthogonal pseudonoise sequences.

17. The apparatus of claim 14, wherein the transmitter identification module comprises:
a transmitter identification information module to obtain Transmitter Identification Information (TII) from the Null symbol of the DAB transmission frame;
wherein the transmitter identification module is further adapted to identify the transmitter of the wireless signal representing the DAB transmission frame based on the Transmitter Identification Information.

18. The apparatus of claim 14, further comprising:
a receiver adapted to receive the wireless signal representing the DAB transmission frame.

19. The apparatus of claim 14, further comprising:
a pseudorange module adapted to obtain a pseudorange based on the pseudonoise sequence.

20. The apparatus of claim 19, further comprising:
a position module adapted to determine a position of the apparatus based on the pseudorange.

21. The apparatus of claim 14:
wherein the wireless signal is a Terrestrial-Digital Multimedia Broadcasting (T-DMB) signal.

22. Computer-readable media embodying instructions executable by a computer to perform a method comprising:
identifying a transmitter of a wireless signal representing a digital audio broadcast (DAB) transmission frame based on a pseudonoise sequence present in a Null symbol of the DAB transmission frame.

23. The computer-readable media of claim 22, wherein the method further comprises:
identifying the transmitter based on the pseudonoise sequence and a chip rotation of the pseudonoise sequence.

24. The computer-readable media of claim 22:
wherein the pseudonoise sequence is selected from a group of mutually orthogonal pseudonoise sequences.

25. The computer-readable media of claim 22, wherein the method further comprises:
obtaining Transmitter Identification Information (TII) from the Null symbol of the DAB transmission frame; and
identifying the transmitter of the wireless signal representing the DAB transmission frame based on the Transmitter Identification Information.

26. The computer-readable media of claim 22, wherein the method further comprises:
obtaining a pseudorange based on the pseudonoise sequence.

27. The computer-readable media of claim 26, wherein the method further comprises:
determining a position of a receiver of the wireless signal based on the pseudorange.

28. The computer-readable media of claim 22:
wherein the wireless signal is a Terrestrial-Digital Multimedia Broadcasting (T-DMB) signal.
